(19) United States
(12) Patent Application Publication
(10) Pub. No.: US 2008/0033580 A1
(43) Pub. Date: Feb. 7, 2008

(54) Analyzer

(75) Inventors: Takamichi Naito, Kobe (JP); Hiromi Onomichi, Kobe (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/827,698

(22) Filed: Jul. 13, 2007

Related U.S. Application Data
(63) Continuation of application No. 10/601,017, filed on Jun. 20, 2003, now abandoned.

(30) Foreign Application Priority Data
Jun. 21, 2002 (JP) 2002-181872

(51) Int. Cl. G05B 15/00

(52) U.S. Cl. 700/83

(57) ABSTRACT

Analyzers are described that include a display for displaying a screen selected from a plurality of screens, which may display a hierarchical menu corresponding to a predetermined screen.

### BACKGROUND

The present invention relates to analyzers such as blood analyzers, urine analyzers, microbe analyzers for detecting the number of microbes contained in a sample, heart sound analyzer and the like.

Analyzers have become progressively more compact in recent years. Typically, analyzers are provided with a user interface (e.g., a pop-up window), which receives instructions from the user of the analyzer, and displays the analysis results. User interfaces have become more compact in conjunction with the increasing compactness of analyzers.

A user interface used in the medical welfare installation management system described in Japanese Unexamined Patent Publication No. H9-65452 is rendered compact by displaying a button for deploying a pop-up window on a plan view.

The pop-up window is advantageous inasmuch as it is capable of displaying a great deal of information in a small space, but is disadvantageous in that it hides the information displayed behind it. In order to confirm the hidden information, the pop-up window must be closed or alternatively moved. Accordingly, complex operations are required when a user is busy working with the pop-up window.

### SUMMARY

The scope of the present invention is defined solely by the appended claims, and is not affected to any degree by the statements within this summary.

By way of introduction, a first analyzer embodying features of the present invention includes a memory for storing a plurality of screens and hierarchical menus corresponding to predetermined screens, a screen display means for controlling to display a screen selected from a plurality of screens; a hierarchical menu display means for controlling to display a hierarchical menu corresponding to a predetermined screen while the predetermined screen is being displayed; a selection means for selecting one command from the hierarchical menu; and a control means for controlling the analyzer in accordance with a selected command. The hierarchical menu is used to specify a single command from among a plurality of operation commands.

A second analyzer embodying features of the present invention includes a display for displaying a predetermined screen selected from a first screen, a second screen, and a main screen; and a controller for controlling to display the predetermined screen on the display. Either the first screen or the second screen corresponds to a hierarchical menu. The main screen includes a first link for linking to the first screen and a second link for linking to the second screen.

A third analyzer embodying features of the present invention includes an assay mechanism for obtaining a signal from a sample; a touch panel display for displaying a predetermined screen selected from a first screen that includes a function button for opening a hierarchical menu and a second screen; a controller for controlling to display the predetermined screen on a display and analyzing signals; and a body for housing the assay mechanism and the controller.

A fourth analyzer embodying features of the present invention includes a display for displaying a display screen that includes a first region for displaying a start button for starting analysis of a sample and a second region for displaying a predetermined screen selected from a first screen and a main screen; and a controller for controlling to display the display screen on the display. The first screen includes a function button for opening a hierarchical menu. The main screen includes a first link button for linking to the first screen. The start button is displayed when at least one of the first screen and the main screen is displayed.

### BRIEF DESCRIPTION OF THE DRAWINGS

FIG. 1 shows a perspective view of a microbe detection device 100.

FIG. 2 shows a schematic view of a first microbe detection device 100 embodying features of the present invention.

FIG. 3 shows a display screen displayed on a display 2.

FIG. 4 is a flow chart briefly outlining the general processing sequence of the controller 17.

FIG. 5 shows the display 2 when a main screen 21 is displayed.

FIG. 6 shows the display 2 when an assay screen 22 is displayed.

FIG. 7 shows the display 2 when a stored sample screen 23 is displayed.

FIG. 8 shows the display 2 when a quality control screen 24 is displayed.

FIG. 9 shows the display 2 when a reagent replacement screen 25 is displayed.

FIG. 10 shows the display 2 when a status display screen 26 is displayed.

FIG. 11 shows the display 2 when a maintenance screen 27 is displayed.

FIG. 12 shows the display 2 when a setting screen 28 is displayed.

FIG. 13 shows the display 2 when a shutdown screen 29 is displayed.

FIG. 14 is a flow chart showing details of the process in S2.

FIG. 15 is a flow chart showing details of the process in S3.

FIG. 16 is a flow chart showing details of the process in S4.

FIG. 17 shows a hierarchical menu 143.

FIG. 18 shows the display 2 when the hierarchical menu 143 is displayed.

FIGS. 19a and 19b are flow charts showing details of the process in S83.

FIG. 20 shows a hierarchical menu 159.

FIG. 21 shows a hierarchical menu 163.

FIG. 22 shows a hierarchical menu 167.

FIG. 23 is a flow chart showing details of the process in S11.

FIG. 24 shows a schematic view a second microbe detection device of embodying features of the present invention.

### DETAILED DESCRIPTION OF THE PRESENTLY PREFERRED EMBODIMENTS

The present invention is described hereinafter in reference to the drawings. Although the following description makes reference to a microbe detection device for purposes of illustration, this description should not be considered to limit the invention in any way. It is to be understood that alternative types of analyzer devices including but not limited to blood analyzers, urine analyzers, microbe analyzers, heart sound analyzers, and the like may also be made and used in accordance with the description herein.

Analyzers embodying features of the present invention display a button for displaying a hierarchical menu, as will be further described hereinbelow.

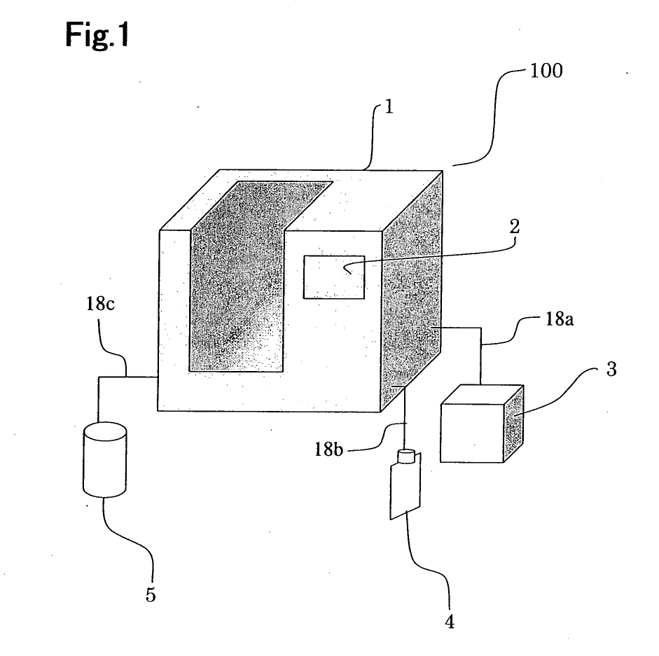

FIG. 1 is a perspective view showing an overview of a microbe detection device 100. A display 2 is mounted on the body 1 of the microbe detection device 100. The display 2 is preferably a touch panel-type display for executing various display functions and input on the same screen. That is, the display 2 both displays various functions and receives the input of operation instructions from a user. Furthermore, the display 2 displays information such as analysis results and the like.

The display 2 is preferably provided with pressure-sensitive sensors on the display elements, such as may be formed by liquid crystals. Various icons, such as buttons and the like are displayed on the display 2. When a user touches a region in which an icon is displayed on the display 2, the pressure-sensitive sensors detect the change in pressure and generate a signal.

A sheath fluid tank 3 and a stain fluid tank 4 are connected to the body 1 through tubes 18a and 18b, respectively. In addition, a discard fluid tank 5 for accumulating discard fluid discharged after sample assays is connected to the body 1 through a tube 18c.

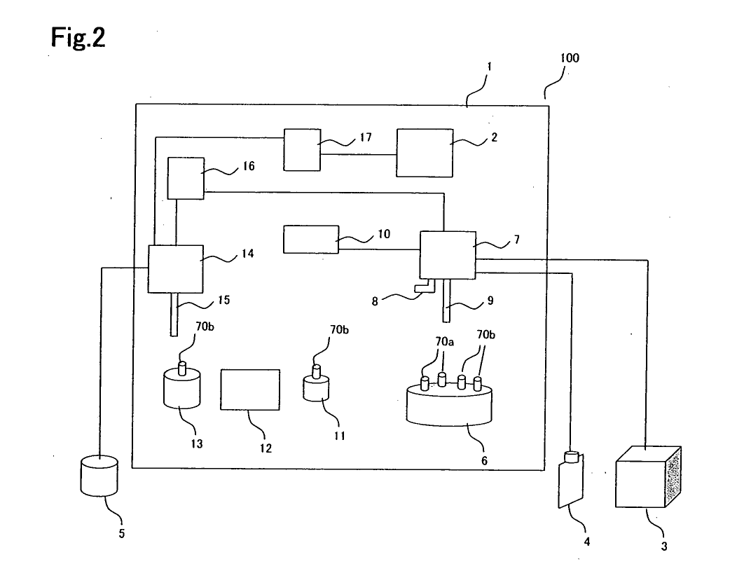

FIG. 2 shows the structure of the body 1. The body 1 includes a loading mechanism 6, a preparation mechanism 7, a heating mechanism 11, a waste box 12, a second loading mechanism 13, an assay mechanism 14, a quantity metered pump 10, a vacuum source 16, a display 2, and a controller 17.

The loading mechanism 6 accommodates a cuvette 70a containing a sample such as urine or the like, and an empty cuvette 70b. The cuvettes 70a and 70b are loaded in the loading mechanism 6 by a user.

The preparation mechanism 7 is provided with a catcher 8 and a pipette 9. The preparation mechanism 7 is connected to the sheath fluid tank 3, stain fluid tank 4, quantity metered pump 10, and vacuum source 16. The preparation mechanism 7 suctions sheath fluid and stain fluid from the sheath fluid tank 3 and the stain fluid tank 4 via the operation of the vacuum source 16. The catcher 8 supports the cuvettes 70a and 70b.

The preparation mechanism 7 suctions and ejects sample through the pipette 9 via the operation of the quantity metered pump 10.

The preparation mechanism 7 supports the cuvette 70b loaded in the loading mechanism 6 by the catcher 8, and transports it to the heating mechanism 11.

The preparation mechanism 7 suctions the sample from within the cuvette 70a loaded in the loading mechanism 6 through the pipette 9. Then, the preparation mechanism 7 ejects the sample from the pipette 9 into the empty cuvette 70b transported to the heating mechanism 11 by the preparation mechanism 7. Next, the preparation mechanism 7 ejects stain fluid and sheath fluid from the pipette 9 into the cuvette 70b into which the sample has been introduced.

The cuvette 70b containing the sample, stain fluid and sheath fluid is heated by the heating mechanism 11.

Then, the preparation mechanism 7 transports the cuvette 70b heated by the heating mechanism 11 and supported by the catcher 8 to the second loading mechanism 13.

In this way, the second loading mechanism 13 loads the cuvette 70b containing the sample, which has been subjected to processing such as staining and heating.

The assay mechanism 14 is provided with a pipette 15. The assay mechanism 14 suctions sample from the cuvette 70b loaded in the second loading mechanism 13 through the pipette 15 via the operation of the vacuum source 16. The assay mechanism 14 obtains an optical signal by irradiating the suction sample with light, converts this signal to a digital signal, and transmits the digital signal to the controller 17. The assay mechanism 14 discards the measured sample to the waste tank 5.

Then, the preparation mechanism 7 transports the cuvette 70b, which the sample has been suctioned from by the assay mechanism 14 and which is maintained by the catcher 8, from the second loading mechanism 13 to the waste box 12 for discard.

The cuvettes 70a and 70b are discarded in the waste box 12. The controller 17 includes a CPU as a control center, ROM for storing basic programs such as a BIOS and the like, RAM that operates as a work region, and compact flash memory (registered trademark) having the function of storing applications and data. A hard disk drive also may be used instead of a compact flash memory.

The controller 17 has the functions of receiving signals transmitted from the assay mechanism 14 and calculating analysis results. In addition, the controller 17 has the functions of receiving signals transmitted from the display 2 and executing processing for displaying information, such as analysis results, on the display 2.

The controller 17 has the functions of displaying a main screen, displaying link buttons, displaying a start button, displaying a help button, determining whether or not the start button is valid, selecting each type of screen, storing each type of screen, displaying hierarchical menus, storing hierarchical menus, and the like.

The controller 17, as further described below, stores a main screen, assay screen, stored sample screen, quality control screen, reagent replacement screen, status display screen, maintenance screen, setting screen, and shutdown screen. Furthermore, the controller 17 stores hierarchical menus corresponding to the stored sample screen, quality control screen, maintenance screen, and setting screen, respectively.

The hierarchical menus are used to specify one among a plurality of operation commands.

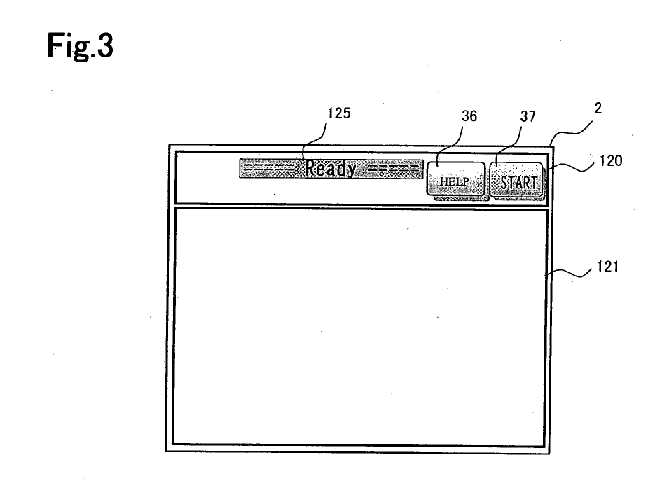

FIG. 3 illustrates the structure of a display screen displayed on the display 2. The display screen displayed on the display 2 includes a first region 120 and a second region 121. The first region 120 is a region disposed at the upper part of the display screen. In the first display region 120 are displayed a preparation display area 125 for displaying whether or not analysis can be performed, a help button 36 for displaying method of using the device, and a start button 37 for starting sample analysis. Reference number 121 refers to a second region. The second region 121 is a region disposed below the first region. In the second region 121, as further described below, are displayed various types of screens such as the main screen, assay screen, and the like. The surface area of the first region 120 is preferably less than the surface area of the second region 121.

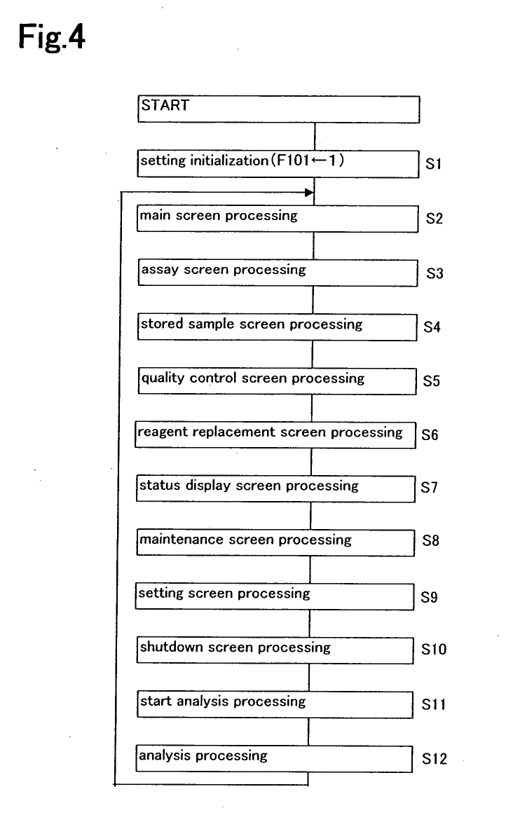

The processes executed by the controller 17 and the screens displayed on the display 2 by these processes are described below. FIG. 4 is a flow chart showing a brief summary of the processing sequence in the controller 17.

In S1, settings are initialized. In the setting initialization, power is supplied to the controller 17, the OS (operating system; in this example the Linux operating system is used) is started, and thereafter the control program of the microbe detection device 100 is read from the compact flash memory and processing begins. In this initialization process, processing is executed to initialize the CPU and display an initialization screen.

In S1, processing is executed to set the assay screen flag F101 to [1] so as to display the assay screen as the initialization screen. Furthermore, processing is executed to set the stored sample screen flag F102, quality control screen flag F103, reagent replacement screen flag F104, status display screen F105, maintenance screen flag F106, setting screen flag F107, and shutdown screen flag F108 at [0].

In S2, processing is executed to display the main screen on the display 2, and information input is received from the various buttons on the main screen.

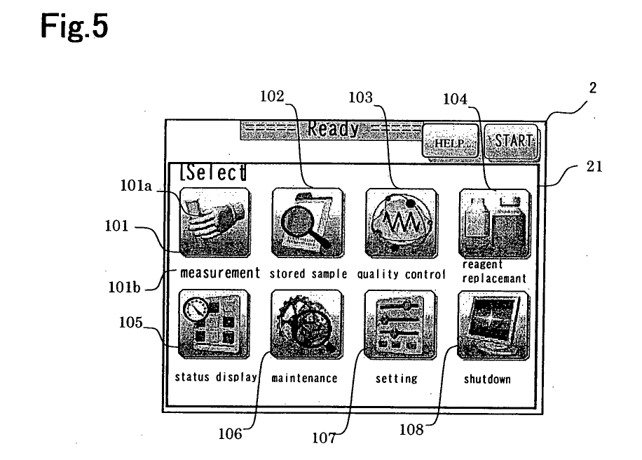

FIG. 5 shows the condition of the display 2 when the main screen 21 is displayed. The main screen 21 is displayed in the second region 121 (refer to FIG. 3). In the main screen 21 are displayed a measurement button 101 for switching the main screen 21 to the assay screen, stored sample button 102 for switching the main screen 21 to the stored sample screen, quality control button 103 for switching the main screen 21 to the quality control screen, reagent replacement button 104 for switching the main screen 21 to the reagent replacement screen, status display button 105 for switching the main screen 21 to the status display screen, maintenance button 106 for switching the main screen 21 to the maintenance screen, setting button 107 for switching the main screen 21 to the setting screen, and shutdown button 108 for switching the main screen 21 to the shutdown screen.

The assay button 101 preferably includes an image area 101a graphically illustrating the purpose for which this button is used. Furthermore, below the assay button 101 is displayed a text area 101b textually describing the purpose for which this button is used. Other buttons are similarly structured. In this way, a user can grasp the purpose for which the button is used both graphically and textually.

In S3 (refer to FIG. 4), processing is executed for displaying the assay screen on the display 2, and receiving information input from the various buttons in the assay screen.

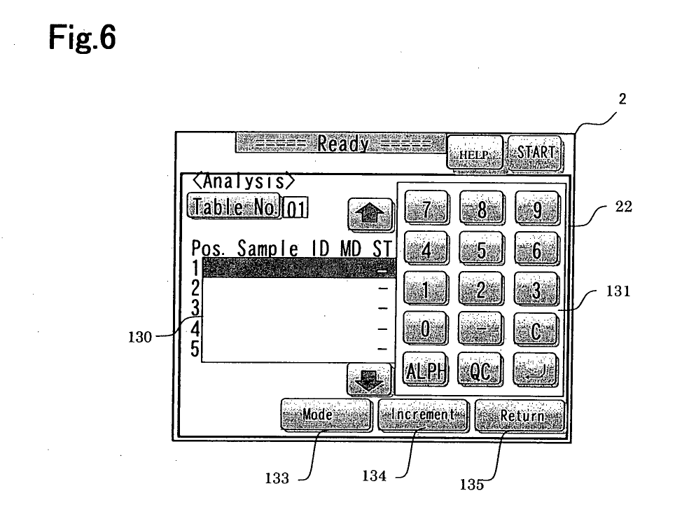

FIG. 6 shows the display 2 when the assay screen 22 is displayed. The assay screen 22 is a screen used for starting sample analysis. The assay screen 22 is displayed in the second region 121 (refer to FIG. 3). In the assay screen 22 are displayed a number display area 130 for displaying the sample number and sample loading position, a ten-key pad 131 used for inputting the sample number and the like, a mode button 133 for changing the assay mode, an increment button 134 used for consecutively inputting sample numbers, and a return button 135 for switching to the main screen 21 (refer to FIG. 5.), and the like.

In S4 (refer to FIG. 4), processing is executed for displaying the stored sample screen on the display 2, and for receiving information input from the various buttons in the stored sample screen.

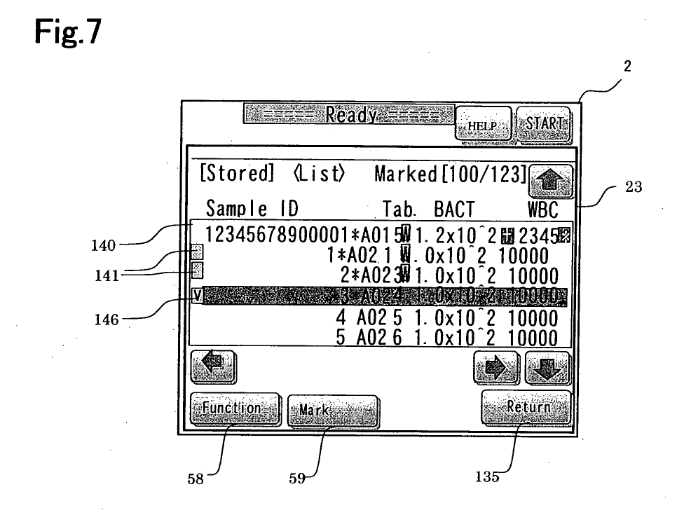

FIG. 7 shows the display 2 when the stored sample screen 23 is displayed. The stored sample screen 23 is a screen for displaying a list of sample analysis results. The stored sample screen 23 is displayed in the second region 121 (refer to FIG. 3). In the stored sample screen 23 are displayed an analysis results area 140 for displaying a list of sample analysis results, a function button 58 for displaying a hierarchical menu, a mark button 59 for marking selected analysis results among those displayed in the analysis result area 140, a return button 135, and the like. The return button 135, as previously mentioned, is used to switch to the main screen 21 (refer to FIG. 5). Reference number 141 refers to a mark (validation mark) applied by the user to validate that a correct analysis result has been obtained and can be input from the hierarchical menu.

Reference number 146 refers to a mark applied by input from the mark button 59. The hierarchical menu displayed when there is input from the function button 58 is described below. A shutdown button for switching to the stored sample screen 23 may also be provided in the assay screen 22 (refer to FIG. 6).

In S5 (refer to FIG. 4), processing is executed for displaying the quality control screen on the display 2, and for receiving information input from the various buttons in the quality control screen.

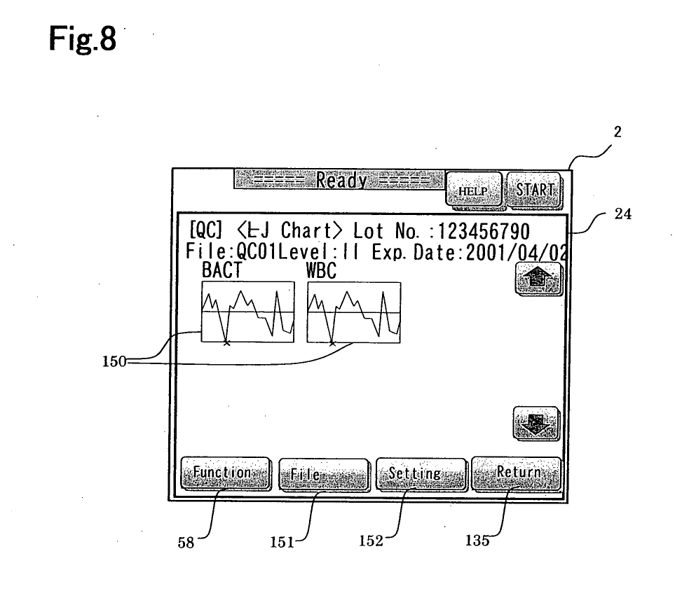

FIG. 8 shows the display 2 when the quality control screen 24 is displayed. The quality control screen 24 is a screen for displaying statistical graphs of results obtained by executing quality control.

The quality control screen 24 is displayed in the second region 121 (refer to FIG. 3). In the quality control screen 24 are displayed a graph display area 150 for displaying quality control statistical graphs, a function button 58, a file button 151, a setting button 152, a return button 135, and the like. The function button 58, as previously mentioned, is used for displaying a hierarchical menu. The file button 151 is used for selecting saved files containing quality control statistical graphs. The setting button 152 is used for setting the quality control method. The return button 135, as previously mentioned., is used for switching to the main screen. 21 (refer to FIG. 5). The hierarchical menu displayed by input from the function button 58 is described below.

In S6 (FIG. 4), processing is executed for displaying the reagent replacement screen on the display 2, and for receiving information input from the various buttons in the reagent replacement screen.

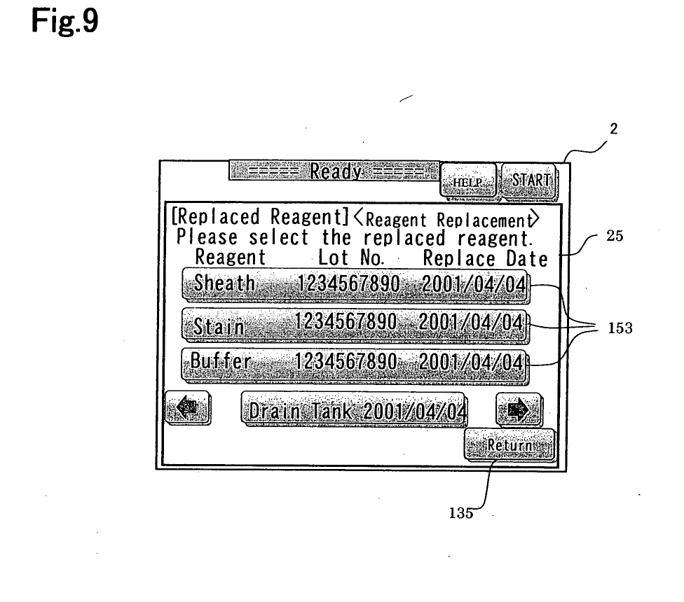

FIG. 9 shows the display 2 when the reagent replacement screen 25 is displayed. The reagent replacement screen 25 is a screen for inputting information such as the replacement date, reagent lot number, and the like when a user replaces a reagent. The reagent replacement screen 25 is displayed in the second region 121 (refer to FIG. 3). In the reagent replacement screen 25 are displayed replacement buttons 153 for inputting new reagent information, a return button 135, and the like. The return button 135, as previously mentioned, is used for switching to the main screen 21 (refer to FIG. 5).

In S7 (refer to FIG. 4), processing is executed for displaying the status display screen on the display 2, and for receiving information input from the various buttons in the status display screen.

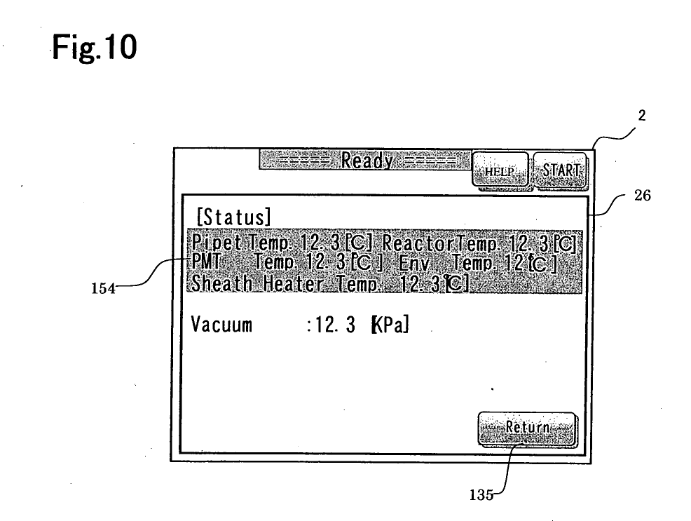

FIG. 10 shows the display 2 when the status display screen 26 is displayed. The status display screen 26 is a screen for displaying the status of the device, such as the internal temperature of the pipette 9 (FIG. 2), the pressure of the vacuum source 16, and the like. The status display screen 26 is displayed in the second region 121 (FIG. 3). In the status display screen 26 are displayed a temperature area 154 for displaying the temperature of each mechanism, a return button 135, and the like. The return button 135, as previously mentioned, is used for switching to the main screen 21 (refer to FIG. 5).

In S8 (FIG. 4), processing is executed for displaying the maintenance screen on the display 2, and for receiving information input from the various buttons in the maintenance screen.

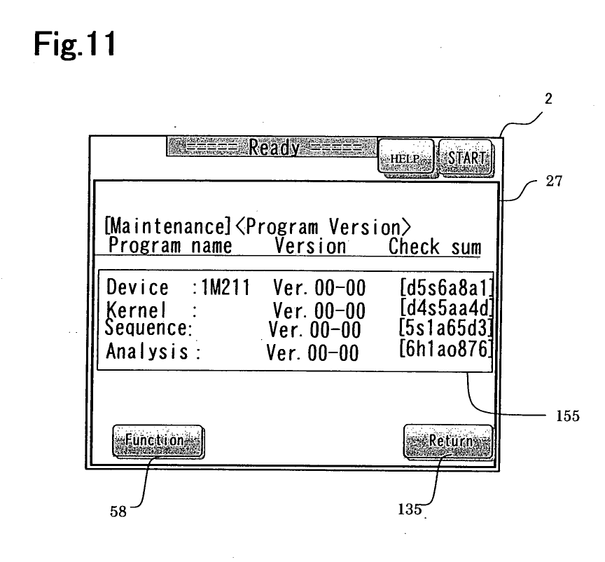

FIG. 11 shows the display 2 when the maintenance screen 27 is displayed. The maintenance screen 27 is a screen for confirming installed program versions and cleaning mechanisms and for performing operation testing and the like. The maintenance screen 27 is displayed in the second region 121 (FIG. 3). In the maintenance screen 27 are displayed a version display area 155 for displaying the program version, a function button 58, a return button 135, and the like. The return button 135, as previously mentioned, is used for switching to the main screen 21 (refer to FIG. 5). The hierarchical menu displayed by input from the function button 58 is described below.

In S9 (FIG. 4), processing is executed for displaying the setting screen on the display 2, and for receiving information input from the various buttons in the setting screen.

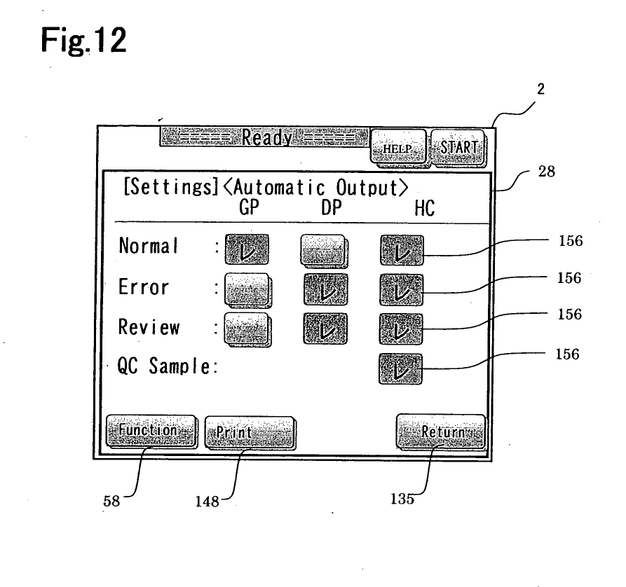

FIG. 12 shows the display 2 when the setting screen 28 is displayed. The setting screen 28 is a screen used for selecting the type of analysis result to be transmitted to another device, such as a printer host computer or the like. The setting screen 28 is displayed in the second region 121 (FIG. 3). In the setting screen 28 are displayed a selection button 156 for selecting whether or not to transmit specified data to another device, a function button 58, a print button 148 for printing the content displayed on the setting screen 28, and a return button 135. The return button 135, as previously mentioned, is used for switching to the main screen 21 (refer to FIG. 5). The hierarchical menu displayed by input from the function button 58 is described below.

In S10 (FIG. 4), processing is executed for displaying the shutdown screen on the display 2, and for receiving information input from the various buttons in the shutdown screen.

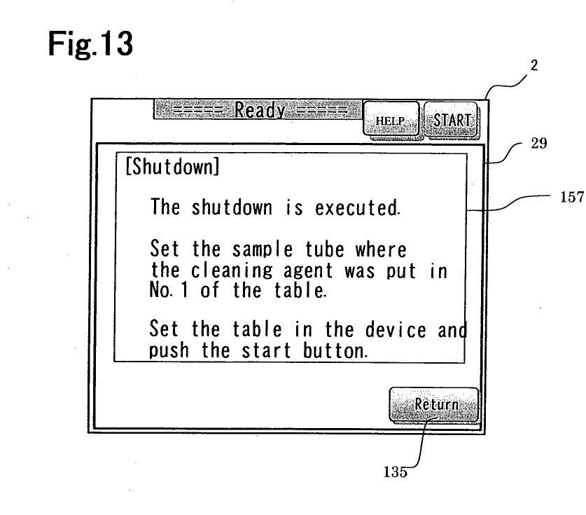

FIG. 13 shows the display 2 when the shutdown screen 29 is displayed. The shutdown screen 29 is a screen for displaying descriptions of the sequence executed to turn off (shutdown) the power source of the microbe detection device 100. The shutdown screen 29 is displayed in the second region 121 (FIG. 3). In the shutdown screen 29 are displayed a sequence display area 157 for displaying the shutdown sequence, a return button 135, and the like. The return button 135, as previously mentioned, is used for switching to the main screen 21 (refer to FIG. 5).

In S11 (FIG. 4), processing is executed for determining whether or not to start analysis when there is input from the start button 37 (FIG. 3), and for starting analysis when prescribed.

In S12 (FIG. 4), processing is executed for performing the analysis operation of a sample by each mechanism, and for calculating analysis results.

The processes of S2 through S12 are sequentially repeated.

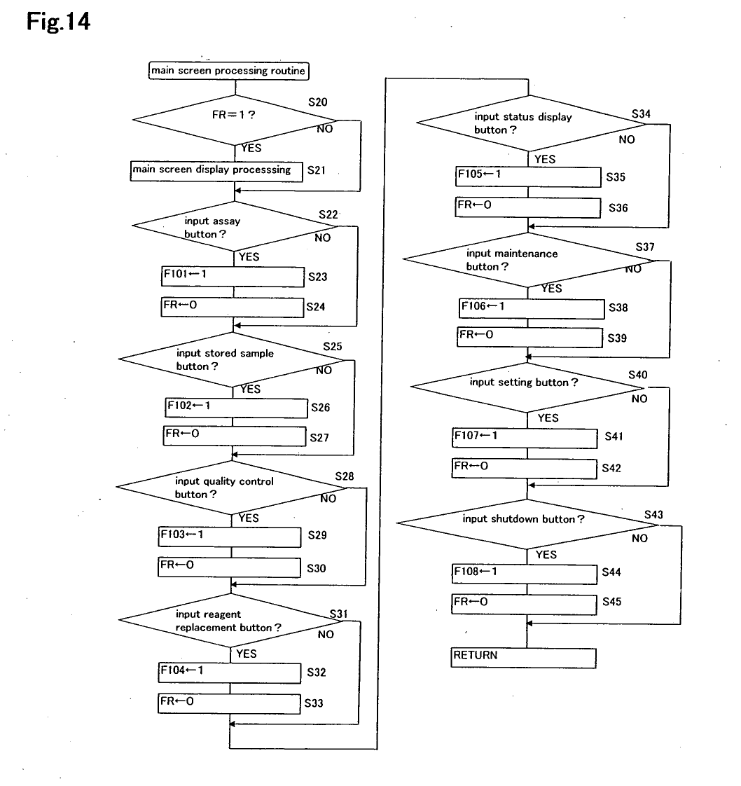

The main screen processes of S2 in FIG. 4 are described below with reference to FIG. 14. FIG. 14 is a flow chart showing details of the process executed in S2.

In S20, a check is made to determine whether or not the return flag FR is set to [1]. The return flag FR is set to [1] when there is input from the return button 135 (FIG. 6). If the return flag FR is set to [1], processing is executed to set the return flag FR to [0], and thereafter the routine advances to S21. If the return flag FR is not set at [1], the routine advances to S22.

In S21, processing is executed for displaying the main screen 21.

In S22, processing is executed to determine whether or not there is input from the assay button 101. If there is input, processing is executed to set the assay screen flag F101 to [1] (S23). In S24, processing is executed to set to [0] the stored sample screen flag F102, quality control screen flag F103, reagent replacement screen flag F104, status display screen flag F105, maintenance screen flag F106, setting screen flag F107, shutdown screen flag F108, and return flag FR. If there is no input from the assay button 101, the processes of S23 and S24 are not executed.

In S25, processing is executed to determine whether or not there is input from the stored sample button 102. If there is input, processing is executed to set the stored sample screen flag F102 to [1] (S26). In S27, processing is executed to set to [0] the assay screen flag F101, quality control screen flag F103, reagent replacement screen flag F104, status display screen flag F105, maintenance screen flag F106, setting screen flag F107, shutdown screen flag F108, and return flag FR. If there is no input from the stored sample button 102, the processes of S26 and S27 are not executed.

In S28, processing is executed to determine whether or not there is input from the quality control button 103. If there is input, processing is executed to set the quality control screen flag F103 to [1] (S29). In S30, processing is executed to set to [0] the assay screen flag F101, stored sample screen flag F102, reagent replacement screen flag F104, status display screen flag F105, maintenance screen flag F106, setting screen flag F107, shutdown screen flag F108, and return flag FR. If there is no input from the stored sample button 102, the processes of S26 and S27 are not executed.

In S31, processing is executed to determine whether or not there is input from the reagent replacement button 104. If there is input, processing is executed to set the reagent replacement screen flag F104 to [1] (S32). In S33, processing is executed to set to [0] the assay screen flag F101, stored sample screen flag F102, quality control screen flag F103, status display screen flag F105, maintenance screen flag F106, setting screen flag F107, shutdown screen flag F108, and return flag FR. If there is no input from the reagent replacement button 104, the processes of S32 and S33 are not executed.

In S34, processing is executed to determine whether or not there is input from the status display button 105. If there is input, processing is executed to set the status display flag F105 flag to [1] (S35). In S36, processing is executed to set to [0] the assay screen flag F101, stored sample screen flag F102, quality control screen flag F103, reagent replacement screen flag F104, maintenance screen flag F106, setting screen flag F107, shutdown screen flag F108, and return flag FR. If there is no input from the status display button 105, the processes of S35 and S36 are not executed.

In S37, processing is executed to determine whether or not there is input from the maintenance button 106. If there is input, processing is executed to set the maintenance screen flag F106 flag to [1] (S38). In S39, processing is executed to set to [0] the assay screen flag F101, stored sample screen flag F102, quality control screen flag F103, reagent replacement screen flag F104, status display screen flag F105, setting screen flag F107, shutdown screen flag F108, and return flag FR. If there is no input from the maintenance button 106, the processes of S38 and S39 are not executed.

In S40, processing is executed to determine whether or not there is input from the setting button 107. If there is input, processing is executed to set the setting screen flag F107 to [1] (S41). In S42, processing is executed to set to [0] the assay screen flag F101, stored sample screen flag F102, quality control screen flag F103, reagent replacement screen flag F104, status display screen flag F105, maintenance screen flag F106, shutdown screen flag F108, and return flag FR. If there is no input from the setting button 107, the processes of S41 and S42 are not executed.

In S43, processing is executed to determine whether or not there is input from the shutdown button 108. If there is input, processing is executed to set the shutdown screen flag F108 to [1] (S44). In S45, processing is executed to set to [0] the assay screen flag F101, stored sample screen flag F102, quality control screen flag F103, reagent replacement screen flag F104, status display screen flag F105, maintenance screen flag F106, setting screen flag F107, and return flag FR. If there is no input from the shutdown button 108, the processes of S44 and S45 are not executed.

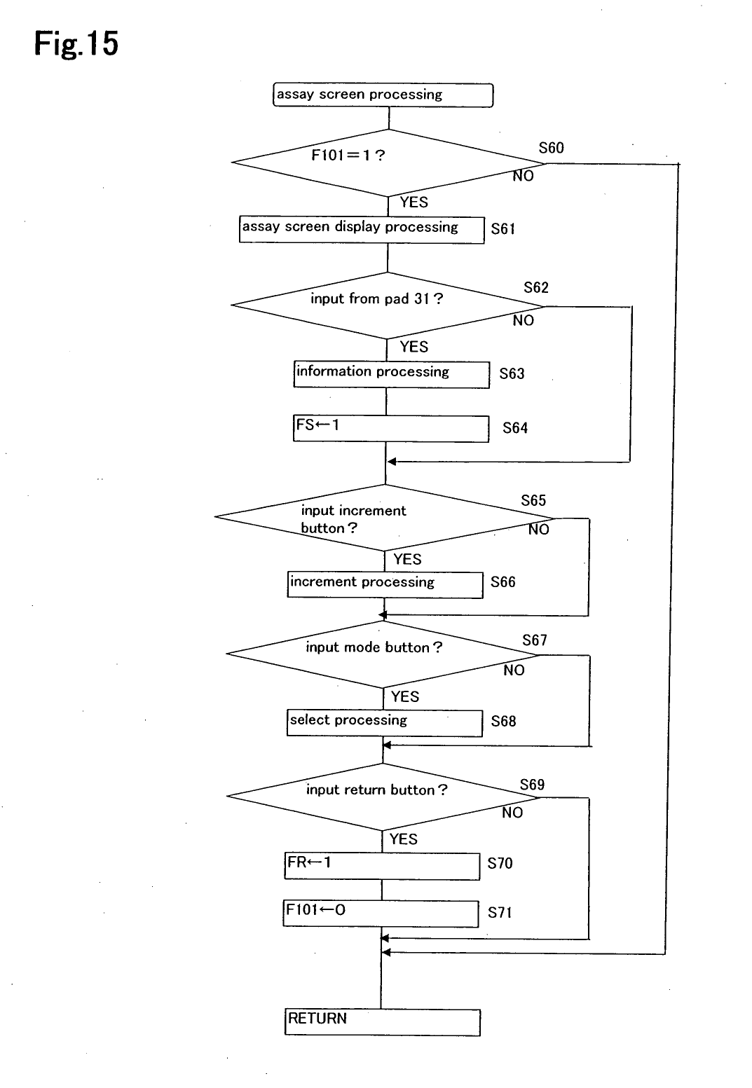

The assay screen process of S3 in FIG. 4 is described below with reference to FIG. 15. FIG. 15 is a flow chart showing details of the processing in S3.

In S60, a check is made to determine whether or not the assay screen flag F101 is set to [1]. If the flag F101 is set to [1], the routine advances to S61, whereas when the flag is not set to [1], the assay screen process ends.

In S61, processing is executed to display the assay screen 22 (FIG. 6).

Since the assay screen flag F101 is set to [1] at initialization shown in S1 (FIG. 3), when the power source of the microbe detection device 100 is turned on, the assay screen 22 is initially displayed in the second region 121 (FIG. 4).

In S62, processing is executed to determine whether or not there is input from the ten-key pad 131 (FIG. 6). If there is input, the routine continues to. S63, whereas when there is no input, the routine advances to S65.

In S63, processing is executed to store the information input from the ten-key pad 131, and display that information in the number display area 130 (FIG. 6).

In S64, processing is executed to set the start flag FS to [1].

In S65, processing is executed to determine whether or not there is input from the increment button 134 (FIG. 6). If there is input, the routine continues to S66, whereas when there is no input, the routine advances to S67

In S66, if a sample number is displayed in the number display area, processing is executed to increment that sample number by 1 and store the incremented number, and display the incremented number in the number display area 130.

In S67, processing is executed to determine whether or not there is input from the mode button 133 (FIG. 6). If there is input, the routine continues to S68, whereas when there is no input, the routine advances to S69.

In S68, processing is executed to select a special analysis mode. In this case, the special analysis mode is a mode for detecting the number of microbes contained in a sample, and detecting the number of leukocytes in the sample.

In S69, processing is executed to determine whether or not there is input from the return button 135 (FIG. 6). If there is input, the routine advances to S70, whereas when there is no input, the assay screen process ends.

In S70, processing is executed to set the return flag FR to [1].

In S71, processing is executed to set the assay screen flag F101 to [0].

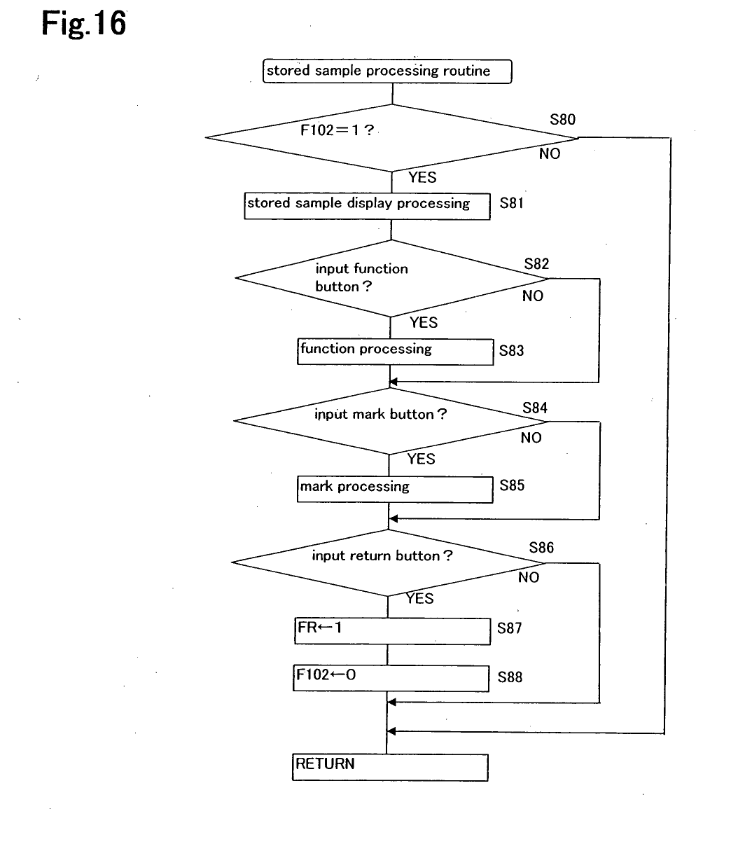

The stored specimen process of S4 in FIG. 4 is described below with reference to FIG. 16. FIG. 16 is a flow chart showing details of the process in S4.

In S80, a check is made to determine whether or not the stored sample flag F102 is set to [1]. If the flag is set to [1], the routine continues to S81, whereas when the flag is not set to [1], the stored sample process ends.

In S81, processing is executed to display the stored sample screen 23 (refer to FIG. 7).

In S82, processing is executed to determine whether or not there is input from the function button 58 (FIG. 7). If there is input, the routine continues to S8.2, whereas when there is no input, the routine advances to S84.

In S83, the function process is executed. The function process is described below.

In S84, processing is executed to determine whether or not there is input from the mark button 59 (FIG. 7). If there is input, the routine continues to S85, whereas when there is no input, the routine advances to S86.

In S85, processing is executed to append a mark 146 on a selected analysis result among those displayed in the analysis result display area 140 (FIG. 7).

In S86, processing is executed to determine whether or not there is input from the return button 135 (FIG. 7). If there is input, the routine continues to S87, whereas when there is no input, the stored sample process ends.

In S87, processing is executed to set the return flag FR to [1].

In S88, processing is executed to set the stored sample screen flag F102 to [0].

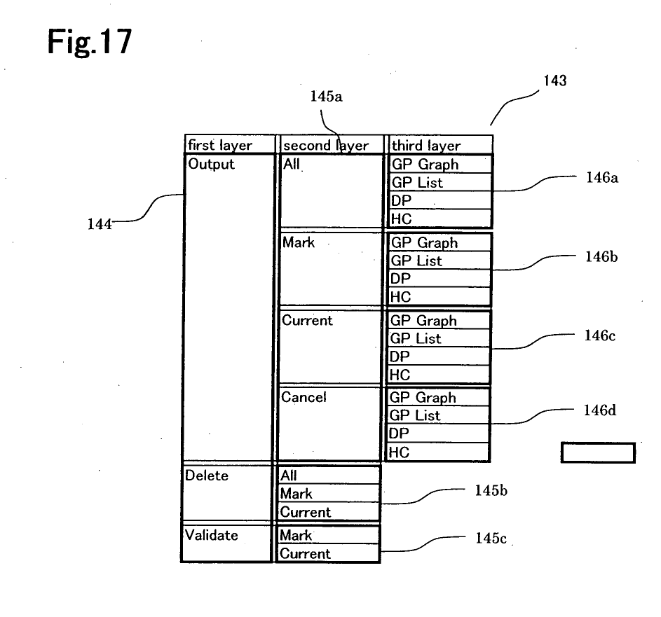

The function process of S83 shown in FIG. 16 and the hierarchical menu are described below with reference to FIGS. 17 through 19. FIG. 17 is an illustration describing the hierarchical menu 143 displayed after there is input from the function button 58.

As shown in FIG. 17, the hierarchical menu 143 includes a first layer, a second layer, and a third layer. The first layer 144 includes an Output button, a Delete button, and a Validate button. The second layer 145a includes an All button, a Mark button, a Current button, and a Cancel button. The second layer 145b includes an All button, a Mark button, and a Current button. The second layer 145c includes a Mark button and a Current button. The third layer 146a, 146b, 146c, and 146d include a GP Graph button, a GP List button, a DP button, and an HC button, respectively.

In the stored sample screen 23 (FIG. 7), when there is input from the function button 58, the Output button, the Delete button, and the Validate button are integratedly displayed over the function button 58 as the first layer 144. When there is output from the Output button of the first layer 144, the All button, the Mark button, the Current button, and the Cancel button are integratedly displayed as the second layer 145a to the right of the first layer 144. When there is input from the All button of the second layer 145a, the GP Graph button, the GP List button, the DP button, and the HC button are integratedly displayed as the third layer 146a to the right of the second layer 145a.

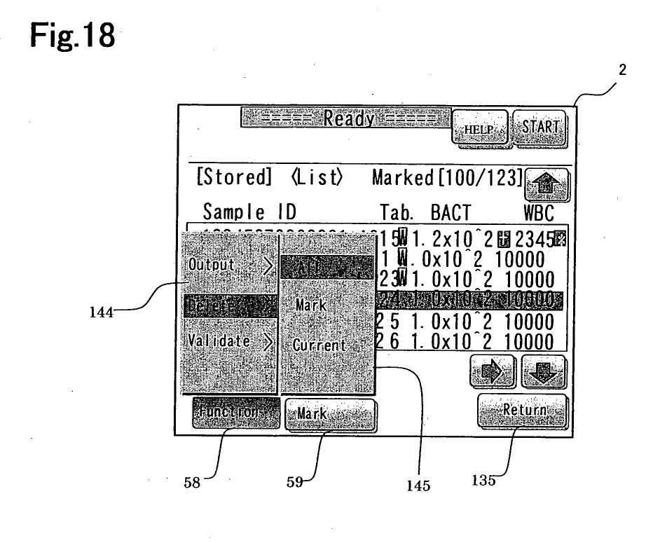

Similarly, when there is input from the Delete button of the first layer, the All button, the Mark button, and the Current button are integratedly displayed as the second layer 145b to the right of the first layer 144. The display 2 in this condition is shown in FIG. 18. As shown in the drawing, the first layer 144 is displayed over the function button 58, and the second layer 145b is displayed on the right of the first layer 144. While the hierarchical menu 143 is displayed, the display color of the function button 58 is preferably a color that is different than the color of the other buttons.

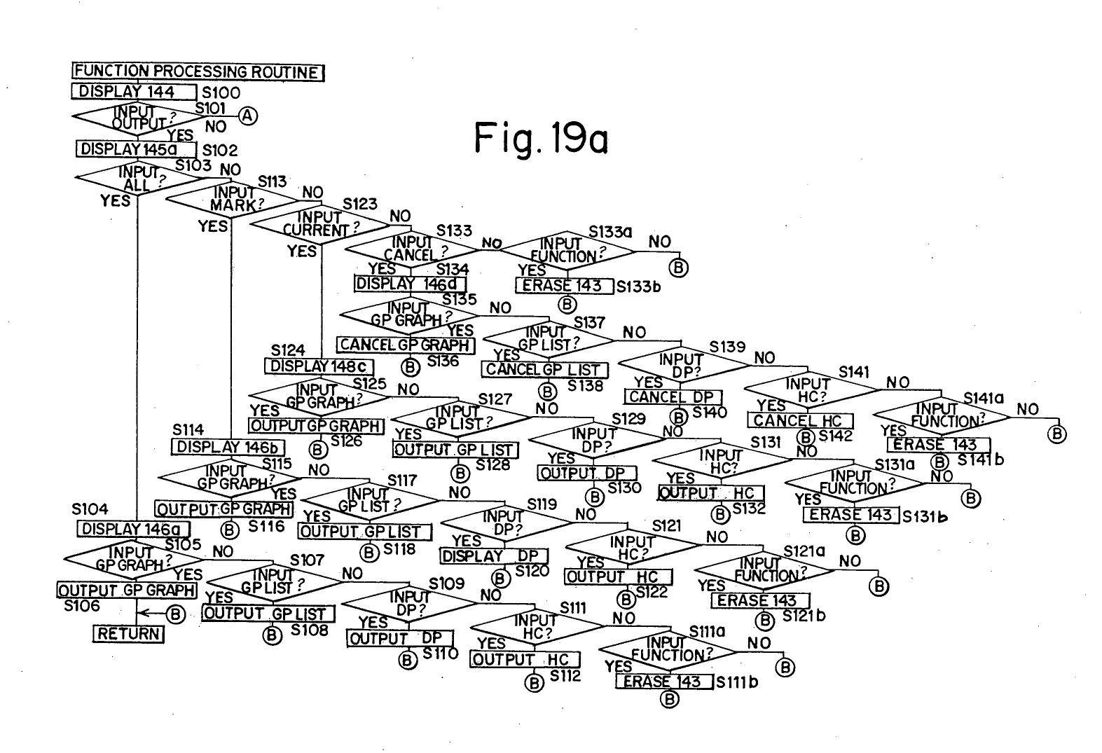

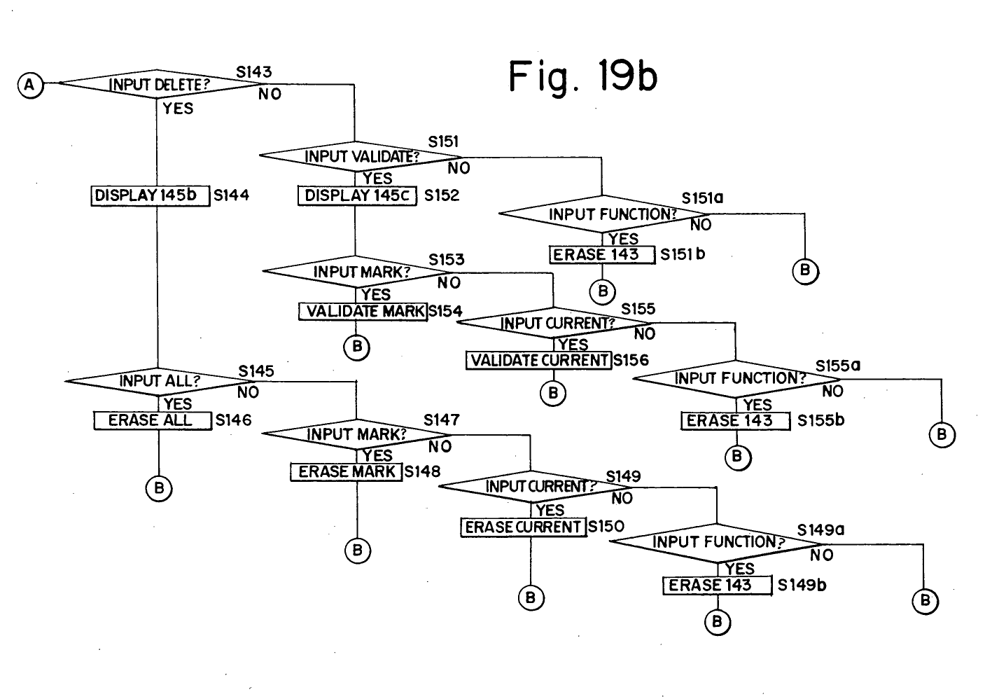

FIGS. 19a and 19b are flow charts showing details of the process in S83.

In S100, processing is executed to display the first layer 144.

In S101, processing is executed to determine whether or not there is input from the Output button of the first layer 144. If there is input, the routine continues to S102, whereas when there is no output, the routine advances to S143 (FIG. 19b).

In S102, processing is executed to display the second layer 145a.

In S103, processing is executed to determine whether or not there is input from the All button of the second layer 145a. If there is input, the routine continues to S104, whereas when there is no input, the routine advances to S113.

In S104, processing is executed to display the third layer 146a.

In S105, processing is executed to determine whether or not there is input from the GP Graph button of the third layer 146a. If there is input, the routine continues to S106, whereas when there is no input, the routine advances to S107.

In S106, processing is executed to attach graphs obtained by the analysis process and output all analysis results displayed in the analysis results display area 140 (FIG. 7) to a graphic printer (GP).

In S107, processing is executed to determine whether or not there is input from the GP List of the third layer 146a. If there is input, the routine continues to S108, whereas when there is no input, the routine advances to S109.

In S108, processing is executed to output all analysis results displayed in the analysis results display area 140 (FIG. 7) without attaching graphs obtained by the analysis process to the graphic printer (GP).

In S109, processing is executed to determine whether or not there is input from the DP button of the third layer 146a. If there is input, the routine continues to S110, whereas when there is no input, the routine advances to S111.

In S110, processing is executed to output all analysis results displayed in the analysis results display area 140 (FIG. 7) to a data printer (DP).

In S111, processing is executed to determine whether or not there is input from the HC button of the third layer 146a. If there is input from the HC button, the routine continues to S112. If there is no input from the HC button, the routine continues to S11a.

In S112, processing is executed to output all analysis results displayed in the analysis results display area 140 (FIG. 7) to a host computer (HC). The host computer is connected to the microbe detection device 100 and other analyzers, and accumulates and stores data transmitted from each analyzer.

In S111a, processing is executed to determine whether or not there is input from the function button 58. If there is input from the function button 58, the routine continues to S111b. If there is no input from the function button 58, the function process routine ends.

In S111b, processing is executed to erase the display of the hierarchical menu 143. After the process of S111b has been executed, the function process ends.

In S113, processing is executed to determine whether or not there is input from the Mark button of the second layer 145a. If there is input, the routine continues to S114, whereas when there is no input, the routine advances to S123.

In S114, processing is executed to display the third layer 146b.

In S115, processing is executed to determine whether or not there is input from the GP Graph button of the third layer 146b. If there is input, the routine continues to S116, whereas when there is no input, the routine advances to S117.

In S116, processing is executed to attach graphs obtained by the analysis process and output analysis results marked by the mark 146 among those results displayed in the analysis results display area 140 (FIG. 7) to the graphic printer (GP).

In S117, processing is executed to determine whether or not there is input from the GP List of the third layer 146b. If there is input, the routine continues to S118, whereas when there is no input, the routine advances to S119.

In S118, processing is executed to output analysis results marked by the mark 146 among those results displayed in the analysis results display area 140 (FIG. 7) to a graphic printer GP without attaching graphs obtained by the analysis process.

In S119, processing is executed to determine whether or not there is input from the DP button of the third layer 146b. If there is input, the routine continues to S120, whereas when there is no input, the routine advances to S121.

In S120, processing is executed to output analysis results marked by the mark 146 among the results displayed in the analysis results display area 140 (FIG. 7) to a data printer (DP).

In S121, processing is executed to determine whether or not there is input from the HC button in the third layer 146b. If there is input from the HC button, the routine continues to S122. If there is no input from the HC button, the routine moves to S121a.

In S122, processing is executed to output analysis results marked by the mark 146 among those results displayed in the analysis results display area 140 (FIG. 7) to a hoist computer (HC).

In S121a, processing is executed to determine whether or not there is input from the function button 58. If there is input from the function button 58, the routine continues to S121b. If there is no input from the function button 58, the function process routine ends.

In S121b, processing is executed to erase the display of the hierarchical menu 143. After the processing of S121b has been executed, the function process ends.

In S123, processing is executed to determine whether or not there is input from the Current button of the second layer 145a. If there is input, the routine continues to S124, whereas when there is no input, the routine advances to S133.

In S124, processing is executed to display the third layer 146c.

In S125, processing is executed to determine whether or not there is input from the GP Graph button of the third layer 146c. If there is input, the routine continues to S126, whereas when there is no input, the routine advances to S127.

In S126, processing is executed to output the newest analysis result among those results displayed in the analysis results display area 140 (FIG. 7) to a graphic printer (GP) with attached graphs obtained by the analysis process.

In S127, processing is executed to determine whether or not there is input from the GP List button of the third layer 146c. If there is input, the routine continues to S128, whereas when there is no input, the routine advances to S129.

In S128, processing is executed to output the newest analysis result among those results displayed in the analysis results display area 140 (FIG. 7) to a graphic printer (GP) without attached graphs obtained by the analysis process.

In S129, processing is executed to determine whether or not there is input from the DP button of the third layer 146c. If there is input, the routine continues to S130, whereas when there is no input, the routine advances to S131.

In S130, processing is executed to output the newest analysis results among those results displayed in the analysis results display area 140 (FIG. 7) to the data printer (DP).

In S131, processing is executed to determine whether or not there is input from the HC button of the third layer 146c. If there is input from the HC button, the routine continues to S132. If there is no input from the HC button, the routine moves to S131a.

In S132, processing is executed to output the newest analysis result among those results displayed in the analysis results display area 140 (FIG. 7) to the host computer (HC).

In S131a, processing is executed to determine whether or not there is input from the function button 58. If there is input from the function button 58, the routine continues to S131b. If there is no input from the function button 58, the function process routine ends.

In S131b, processing is executed to erase the display of the hierarchical menu 143. When the processing of S131b has been executed, the function process ends.

In S133, processing is executed to determine whether or not there is input from the Cancel button of the second layer 145a. If there is input from the Cancel button, the routine continues to S134. If there is no input from the Cancel button, the routine moves to S133a.

In S134, processing is executed to display the third layer 146d.

In S133a, processing is executed to determine whether or not there is input from the function button 58. If there is input from the function button 58, the routine continues to S133b. If there is no input from the function button 58, the function process routine ends.

In S133b, processing is executed to erase the display of the hierarchical menu 143. After the process in S133b has been executed, the function process ends.

In S135, processing is executed to determine whether or not there is input from the GP graph button of the third layer 146d. If there is input, the routine continues to S136, whereas when there is no input, the routine moves to S137.

In S136, processing is executed to stop the output of data to the graphic printer (GP).

In S137, processing is executed to determine whether or not there is input from the GP List button of the third layer 146d. If there is input, the routine continues to S138, whereas when there is no input, the routine moves to S139.

In S138, processing is executed to stop the output of data to the graphic printer (GP).

In S139, processing is executed to determine whether or not there is input from the DP button of the third layer 146d. If there is input, the routine continues to S140, whereas when there is no input, the routine moves to S141.

In S140, processing is executed to stop the output to the data printer (DP).

In S141, processing is executed to determine whether or not there is input from the HC button of the third layer 146d. If there is input from the HC button, the routine continues to S142. If there is no input from the HC button, the routine moves to S141a.

In S142, processing is executed to stop the output of data to the host computer (HC).

In S141a, processing is executed to determine whether or not there is input from the function button 58. If there is input from the function button 58, the routine continues to S141b. If there is no input from the function button 58, the function process routine ends.

In S141b, processing is executed to erase the display of the hierarchical menu 143. After the process of S141b has been executed, the function process ends.

In S143 (FIG. 19b), processing is executed to determine whether or not there is input from the Delete button of the first layer 144. If there is input, the routine continues to S144, whereas when there is no input, the routine moves to S151.

In S144, processing is executed to display the second layer 145b.

In S145, processing is executed to determine whether or not there is input from the All button of the second layer 145b. If there is input, the routine continues to S146, whereas when there is no input, the routine moves to S147 In S146, processing is executed to erase all analysis results displayed in the analysis results display area 140 (FIG. 7).

In S147, processing is executed to determine whether or not there is input from the Mark button of the second layer 145b. If there is input, the routine continues to S148, whereas when there is no input, the routine moves to S149.

In S148, processing is executed to erase analysis results marked by the mark 146 among those results displayed in the analysis results display area 140 (FIG. 7).

In S149, processing is executed to determine whether or not there is input from the Current button of the second layer 145b. If there is input from the Current button, the routine continues to S150. If there is no input from the Current button, the routine moves to S149a.

In S150, processing is executed to erase the newest analysis result among those results displayed in the analysis results display area 140 (FIG. 7).

In S149a, processing is executed to determine whether or not there is input from the function button 58. If there is input from the function button 58, the routine continues to S149b. If there is no input from the function button 58, the function process routine ends.

In S149b, processing is executed to erase the display of the hierarchical menu 143. After the process of S149b has been executed, the function process ends.

In S151, processing is executed to determine whether or not there is input from the Validate button of the first layer 144. If there is input from the Validate button, the routine continues to S152. If there is no input from the Validate button, the routine moves to S151a.

In S152, processing is executed to display the second layer 145c.

In S151a, processing is executed to determine whether or not there is input from the function button 58. If there is input from the function button 58, the routine continues to S151b. If there is no input from the function button 58, the function process routine ends.

In S151b, processing is executed to erase the display of the hierarchical menu 143. After the process of S151b has been executed, the function process ends.

In S153, processing is executed to determine whether or not there is input from the Mark button of the second layer 145c. If there is input, the routine continues to S154, whereas when there is no input, the routine moves to S155.

In S154, processing is executed to attach a validation mark 141 (FIG. 7) to analysis results marked by the mark 146 among the results displayed in the analysis results display area 140 (FIG. 7).

In S155, processing is executed to determine whether or not there is input from the Current button of the second layer 145c. If there is input from the Current button, the routine continues to S156. If there is no input from the Current button, the routine moves to S155a.

In S156, processing is executed to attach a validation mark 141 (FIG. 7) to the newest analysis result among those results displayed in the analysis results display area 140 (FIG. 7).

In S155a, processing is executed to determine whether or not there is input from the function button 58. If there is input from the function button 58, the routine continues to S155b. If there is no input from the function button 58, the function process routine ends.

In S155b, processing is executed to erase the display of the hierarchical menu 143. After the process of S155b has been executed, the function process ends.

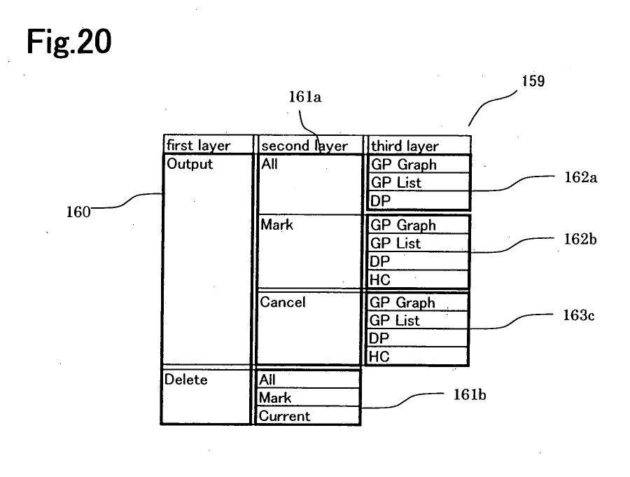

The hierarchical menu 159 displayed after there is input from the function button 58 in the quality control screen 24 (FIG. 8) is described below with reference to FIG. 20.

As shown in FIG. 20, the hierarchical menu 159 includes a first layer, a second layer, and a third layer. The first layer 160 includes an Output button and a Delete button. The second layer 161a includes an All button, a Mark button, and a Cancel button. The second layer 161b includes an. All button, a Mark button, and a Current button. The third layer 162a includes a GP Graph button, a GP List button, and a DP button. The third layers 162b and 162c include a GP Graph button, a GP List button, a DP button, and an HC button.

In the quality control screen 24 (FIG. 8), when there is input from the function button 58, the Output button and the Delete button are integratedly displayed as the first layer 160 over the function button 58. When there is input from the Output button of the first layer 160, the All button, the Mark button, and the Cancel button are integratedly displayed as the second layer 161a to the right of the first layer 160. When there is input from the All button of the second layer 161a, the GP Graph button and the DP button are integratedly displayed as the third layer 162a to the right of the second layer 161a.

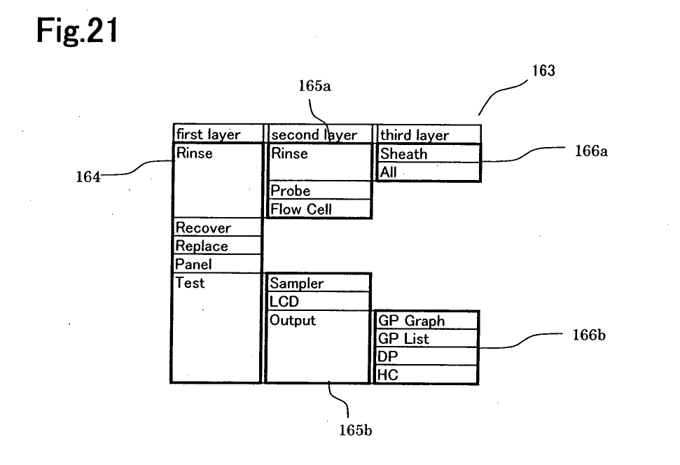

The hierarchical menu 163 displayed after there is input from the function button 58 in the maintenance screen 27 (FIG. 11) is described below with reference to FIG. 21.

As shown in FIG. 21, the hierarchical menu 163 includes a first layer, a second layer, and a third layer. The first layer 164 includes a Rinse button, a Recover button, a Replace button, a Panel button, and a Test button. The second layer 165a includes a Rinse button, a Probe button, and a Flow Cell button. The second layer 165b includes a Sampler button, an LCD button, and an Output button. The third layer 166a includes a Sheath button and an All button. The third layer 166b includes a GP Graph button, a GP List button, a DP button, and an HC button.

In the maintenance screen 27 (FIG. 11), when there is input from the function button 58, the Rinse button, Recover button, Replace button, Panel button, and Test button are integratedly displayed as the first layer 164 over the function button 58. When there is input from the Rinse button of the first layer 164, the Rinse button, Probe button, and Flow Cell button are integratedly displayed as the second layer 165a to the right of the first layer 164. When there is input from the Rinse button of the second layer 165a, the sheath button and the All button are integratedly displayed as the third layer 166a to the right of the second layer 165a.

The Recover button of the first layer 164 is used to start the error recovery process. The Replace button is used to start the replacement of the stain fluid tank 4 (FIG. 1). The Panel button is used to start the calibration of the display 2. The Probe button of the second layer 165a is used to start washing the pipettes 9 and 15 (FIG. 2), and the Flow Cell button is used to start washing the flow cells of the structural parts of the assay mechanism 14. The Sampler button of the second layer 165b is used to start the testing of the operation of the loading mechanism 6. The LCD button is used to start testing of the display 2. The Sheath button of the third layer 166a is used to start washing the flow path through which the sheath fluid flows, and the All button is used to start washing all flow paths. The four buttons of the third layer 166b are used to start tests to determine whether or not data output to external devices is normal.

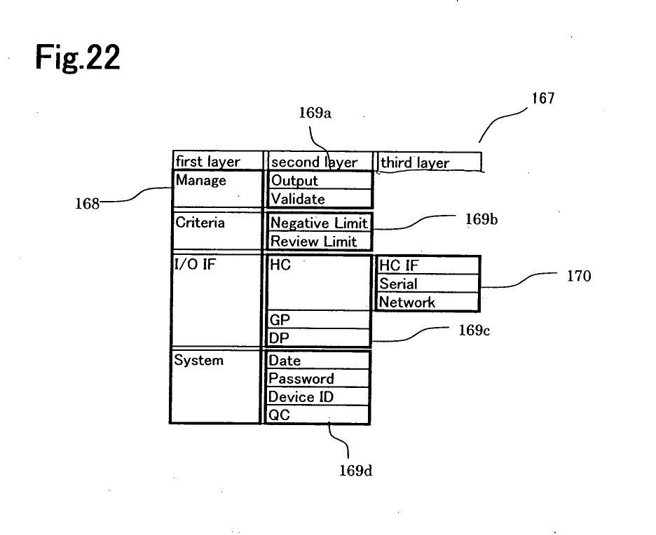

The hierarchical menu 167 displayed after input from the function button 58 in the setting screen 28 (FIG. 12) is described below with reference to FIG. 22.

As shown in FIG. 22, the hierarchical menu 167 includes a first layer, a second layer, and a third layer. The first layer 168 includes a Manage button, a Criteria button, an I/O IF button, and a System button. The second layer 169a includes an Output button and a Validate button. The second layer 169b includes a Negative Limit button and a Review Limit button. The second layer 169c includes an HC button, a P button, and a DP button. The second layer 169d includes a Date button, a Password button, a Device ID button, and a QC button. The third layer 170 includes an HC IF button, a Serial button, and a Network button.

In the setting screen 28 (FIG. 12), when there is input from the function button 58, the Manage button, the Criteria button, the I/O IF button, and the System button are integratedly displayed as the first layer 168 over the function button 58. When there is input from the Manage button of the first layer 168, the Output button and Validate button are integratedly displayed as the second layer 169a to the right of the first layer 168.

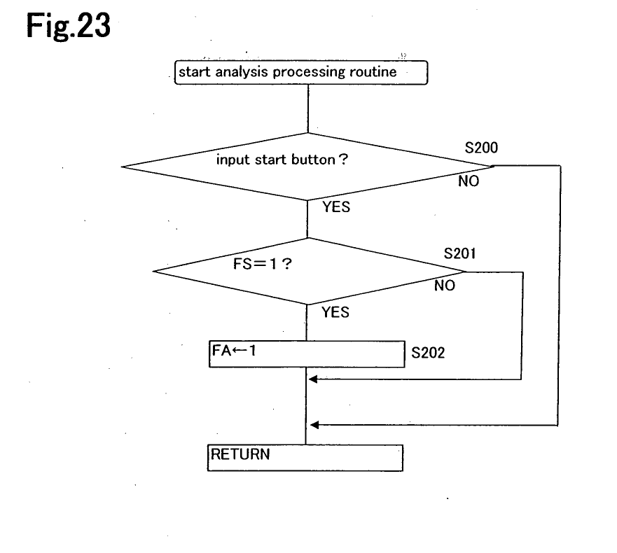

The analysis start process of S11 in FIG. 4 is described below with reference to FIG. 23. FIG. 23 is a flow chart showing details of the process in S11.

In S200, processing is executed to determine whether or not there is input from the start button 37 (FIG. 6). If there is input, the routine continues to S201, whereas when there is no input, the analysis start process ends.

In S201, processing is executed to determine whether or not the start flag FS (refer to S64 in FIG. 15) is set to [1]. If the flag is set to [1], the routine continues to S202, whereas when the flag is not set to [1], the analysis start process ends.

In S202, processing is executed to set the analysis flag FA to [1] to start the operation of each mechanism.

In this way, the microbe detection device 100 starts analyzing if there is input from the start button 37 when a sample number has been input from the setting screen 22, but does not start analysis otherwise. Accordingly, the microbe detection device 100 does not start analysis even if there is input from the start button 37 when the main screen 21 and stored sample screen 23 are displayed.

The controller 17 may also be structured so as to change the start button 37 to a stop button to stop analysis after analysis has started.

Although the microbe analyzer of this embodiment accommodates the control 17 in the body 1, the present invention is not limited to this arrangement.

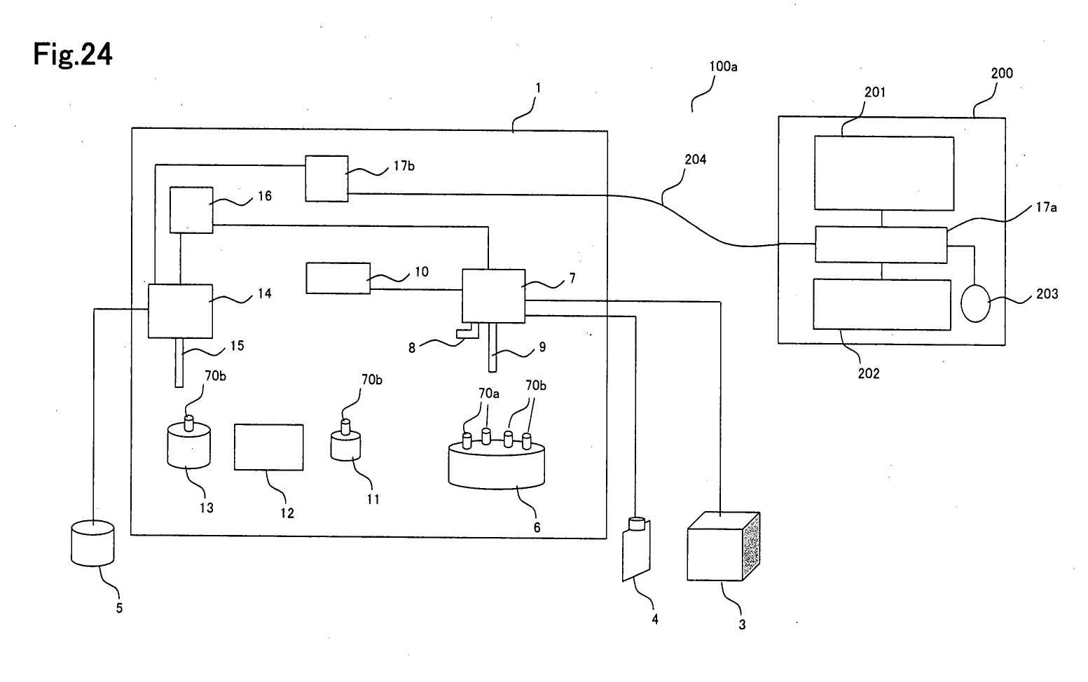

A microbe detection device 100a of a second embodiment is shown in FIG. 24.

The microbe detection device 100a includes a body 1, and a personal computer 200. The body 1 and the personal computer 200 are connected via a connecting cable 204. The personal computer 200 is provided with a CRT display 201, a controller 17a, a keyboard 202, and a mouse 203.

The body 1 is provided with a loading mechanism 6, a preparation mechanism 7, a heating mechanism 11, a waste box 12, a second loading mechanism 13, an assay mechanism 14, a quantity metering pump 10, a vacuum source 16, and a controller 17b.

A sheath fluid tank 3, a stain fluid tank 4, and a discard fluid tank 5 are connected to the body 1. Since the structure is identical to that of the microbe detection device 100 shown in FIG. 2, like reference numbers are used in the drawings. Accordingly, further description of these like parts is omitted.

The controller 17a and the controller 17b are connected through the connecting cable 204. The controller 17a and the controller 17b function as a single controller having functions identical to those of the controller 17 (FIG. 2).

The present invention is applicable to various analyzers, such as blood analyzers (e.g., model XE-2100, Sysmex Corp.), urine analyzers (e.g., model EF-100, Sysmex Corp.) heart sound analyzers, and the like.

The foregoing detailed description has been provided by way of explanation and illustration, and is not intended to limit the scope of the appended claims. Many variations in the presently preferred embodiments illustrated herein will be obvious to one of ordinary skill in the art, and remain within the scope of the appended claims and their equivalents.

1-31. (canceled)

32. An analyzer user interface comprising:
a display for displaying a screen;
operation screen displaying means for displaying an operation screen on the display, the operation screen comprising a menu button for displaying a hierarchical menu for operating the analyzer, the hierarchical menu comprising a first layer and a second layer;
first selecting means for selecting the menu button of the operation screen;
first layer displaying means for displaying the first layer of the hierarchical menu on the operation screen when the menu button is selected by the first selecting means, the first layer comprising a first menu item for displaying the second layer;
second selecting means for selecting the first menu item;
second layer displaying means for displaying the second layer of the hierarchical menu on the operation screen when the first menu item is selected by the second selecting means, the second layer comprising a second menu item for executing an operation of the analyzer;
third selecting means for selecting the second menu item; and
operation executing means for executing the operation when the second menu item is selected by the third selecting means.

33. The analyzer user interface according to claim 32, wherein:
the second layer further comprises a third menu item for executing a second operation of the analyzer which is different from the operation of the second menu item;
the third selecting means selects one of the second menu item and the third menu item; and
the analyzer user interface further comprises second operation executing means for executing the second operation when the third menu item is selected by the third selecting means.

34. The analyzer user interface according to claim 32, wherein:
the hierarchical menu further comprises a third layer;
the second layer further comprises a fourth menu item for displaying the third layer;
the third layer comprises a fifth menu item for executing a third operation of the analyzer which is different from the operation of the second menu item and the second operation of the third menu item;
the third selecting means selects one of the second menu item, the third menu item and fourth menu item; and
the analyzer user interface further comprises:
third layer displaying means for displaying the third layer of the hierarchical menu on the operation screen when the fourth menu item is selected by the third selecting means;
fourth selecting means for selecting the fifth menu item; and
third operation executing means for executing the third operation when the fifth menu item is selected by the fourth selecting means.

35. The analyzer user interface according to claim 34, wherein:
the third layer further comprises a sixth menu item for executing a fourth operation of the analyzer which is different from the operation of the second menu item, the second operation of the third menu item and the third operation of the fifth menu item;
the fourth selecting means selects one of the fifth menu item and sixth menu item; and
the analyzer user interface further comprises fourth operation executing means for executing the fourth operation when the sixth menu item is selected by the fourth selecting means.

36. The analyzer user interface according to claim 32, wherein:
the hierarchical menu further comprises a third layer;
the second layer further comprises a third menu item for displaying the third layer;
the third layer comprises a fourth menu item for executing a second operation of the analyzer which is different from the operation of the second menu item;
the third selecting means selects one of the second menu item and the third menu item; and
the analyzer user interface further comprises:
third layer displaying means for displaying the third layer of the hierarchical menu on the operation screen when the third menu item is selected by the third selecting means;
fourth selecting means for selecting the fourth menu item; and
second operation executing means for executing the second operation when the fourth menu item is selected by the fourth selecting means.

37. The analyzer user interface according to claim 32, further comprising:
main screen displaying means for displaying a main screen on the display, the main screen comprising an operation screen invoking part for displaying the operation screen; and
fourth selecting means for selecting the operation screen invoking part;
wherein the operation screen displaying means displays the operation screen on the display when the operation screen invoking part is selected by the fourth selecting means.

38. The user interface according to claim 37, wherein:
the main screen further comprises a second operation screen invoking part for displaying a second operation screen which does not have a menu button for displaying a hierarchical menu for operating the analyzer;
the fourth selecting means selects one of the operation screen invoking part and the second operation screen invoking part; and
the analyzer user interface further comprises:
second operation screen displaying means for displaying the second operation screen on the display when the second operation screen invoking part is selected by the fourth selecting means.

39. An analyzer user interface comprising:
a display for displaying a screen;
operation screen displaying means for displaying an operation screen on the display, the operation screen comprising a menu button for displaying a hierarchical menu for operating the analyzer, the hierarchical menu comprising a first layer, a second layer and a third layer;
first selecting means for selecting the menu button of the operation screen;
first layer displaying means for displaying the first layer of the hierarchical menu on the operation screen when the menu button is selected by the first selecting means, the first layer comprising a first menu item for displaying the second layer;
second selecting means for selecting the first menu item;
second layer displaying means for displaying the second layer of the hierarchical menu on the operation screen when the first menu item is selected by the second selecting means, the second layer comprising a second menu item for displaying the third layer;
third selecting means for selecting the second menu item;
third layer displaying means for displaying the third layer of the hierarchical menu on the operation screen when the second menu item is selected by the third selecting means, the third layer comprising a third menu item for executing a first operation of the analyzer and a fourth menu item for executing a second operation of the analyzer which is different from the first operation;
fourth selecting means for selecting one of the third menu item and the fourth menu item;
first operation executing means for executing the first operation when the third menu item is selected by the fourth selecting means; and
second operation executing means for executing the second operation when the fourth menu item is selected by the fourth selecting means.

40. The analyzer user interface according to claim 39, wherein:
the second layer further comprises a fifth menu item for executing a third operation of the analyzer which is different from the first operation and the second operation;
the third selecting means selects one of the second menu item and the fifth menu item; and
the analyzer user interface further comprises third operation executing means for executing the third operation when the fifth menu item is selected by the third selecting means.

41. An analyzer user interface comprising:
a display for displaying a screen;
operation screen displaying means for displaying an operation screen on the display, the operation screen comprising a menu button for displaying a hierarchical menu for operating the analyzer, the hierarchical menu comprising a first layer and a second layer;
first selecting means for selecting the menu button of the operation screen;
first layer displaying means for displaying the first layer of the hierarchical menu on the operation screen when the menu button is selected by the first selecting means, the first layer comprising a plurality of menu items which is classified functionally;
second selecting means for selecting one of the plurality of menu items of the first layer;
second layer displaying means for displaying the second layer of the hierarchical menu on the operation screen when one of the plurality of menu items of the first layer is selected by the second selecting means, the second layer comprising a plurality of command items for executing an operation related to the selected menu item of the first layer;
third selecting means for selecting one of the plurality of command items of the second layer displayed by the second layer displaying means; and
operation executing means for executing the operation corresponding to the selected command item when one of the plurality of command items is selected by the third selecting means.

42. The analyzer user interface according to claim 41, further comprising: a memory for storing the hierarchical menu;
wherein:
the first layer displaying means read the first layer of the hierarchical menu from the memory, and display the first layer of the hierarchical menu on the operation screen; and
the second layer displaying means read the second layer of the hierarchical menu from the memory, and display the second layer of the hierarchical menu on the operation screen.

43. The analyzer user interface according to claim 41, wherein:
the hierarchical menu further comprises a third layer;
the second layer further comprises at least one menu item for displaying the third layer;
the third layer comprises a plurality of command items for executing an operation related to the selected menu item of the second layer;
the third selecting means selects one of the plurality of command items of the second layer or the menu item of the second layer displayed by the second layer displaying means; and
the analyzer user interface further comprises:
third layer displaying means for displaying the third layer of the hierarchical menu on the operation screen when the menu item of the second layer is selected by the third selecting means;
fourth selecting means for selecting one of the plurality of command items of the third layer displayed by the third layer displaying means; and
second operation executing means for executing the operation corresponding to the selected command item of the third layer when one of the plurality of command items of the third layer is selected by the fourth selecting means.

44. The analyzer user interface according to claim 41, further comprising:
main screen displaying means for displaying a main screen on the display, the main screen comprising an operation screen invoking part for displaying the operation screen; and
fourth selecting means for selecting the operation screen invoking part;
wherein the operation screen displaying means displays the operation screen on the display when the operation screen invoking part is selected by the fourth selecting means.

45. The user interface according to claim 44, wherein:
the main screen further comprises a second operation screen invoking part for displaying a second operation screen which does not have a menu button for displaying a hierarchical menu for operating the analyzer;
the fourth selecting means selects one of the operation screen invoking part and the second operation screen invoking part; and
the analyzer user interface further comprises:
second operation screen displaying means for displaying the second operation screen on the display when the second operation screen invoking part is selected by the fourth selecting means.

46. An analyzer user interface comprising:
a display for displaying a screen;
operation screen displaying means for displaying an operation screen on the display, the operation screen comprising a menu button for displaying a hierarchical menu for operating the analyzer, the hierarchical menu being configured as a tree structure and comprising a first layer, a second layer and a third layer;
first selecting means for selecting the menu button of the operation screen;
first layer displaying means for displaying the first layer of the hierarchical menu on the operation screen when the menu button is selected by the first selecting means, the first layer comprising a plurality of menu items which is classified by major classification;
second selecting means for selecting one of the plurality of menu items of the first layer;
second layer displaying means for displaying the second layer of the hierarchical menu on the operation screen when one of the plurality of menu items of the first layer is selected by the second selecting means, the second layer comprising a plurality of menu items which is classified by minor classification;
third selecting means for selecting one of the plurality of menu items of the second layer displayed by the second layer displaying means; and
third layer displaying means for displaying the third layer of the hierarchical menu on the operation screen when one of the plurality of menu items of the second layer is selected by the third selecting means, the third layer comprising a plurality of command items for executing an operation related to the selected menu item of the second layer;
fourth selecting means for selecting one of the plurality of command items of the third layer displayed by the third layer displaying means; and
operation executing means for executing the operation corresponding to the selected command item when one of the plurality of command items of the third layer is selected by the fourth selecting means.

47. The analyzer user interface according to claim 46, further comprising: a memory for storing the hierarchical menu;
wherein:
the first layer displaying means read the first layer of the hierarchical menu from the memory, and display the first layer of the hierarchical menu on the operation screen;
the second layer displaying means read the second layer of the hierarchical menu from the memory, and display the second layer of the hierarchical menu on the operation screen; and
the third layer displaying means read the third layer of the hierarchical menu from the memory, and display the third layer of the hierarchical menu on the operation screen.

48. The analyzer user interface according to claim 46, wherein:
the second layer further comprises at least one command item for executing an operation related to the selected menu item of the first layer;
the third selecting means selects one of the plurality of menu items of the second layer or the command item of the second layer displayed by the second layer displaying means; and
the analyzer user interface further comprises:
second operation executing means for executing the operation corresponding to selected command item of the second layer when the command items of the second layer is selected by the third selecting means.
